(19) United States
(12) Patent Application Publication
(10) Pub. No.: US 2018/0257459 A1
(43) Pub. Date: Sep. 13, 2018

(54) FILTER COVER AND AIR CONDITIONING SYSTEM FOR VEHICLE HAVING THE SAME

(71) Applicant: Hanon Systems, Daejeon (KR)

(72) Inventors: Dong Gyun KIM, Daejeon (KR); Si Hyung KIM, Daejeon (KR); Ki Chan PARK, Daejeon (KR); Dae Keun PARK, Daejeon (KR); Eun Suk BAE, Daejeon (KR); Nam Joon LEE, Daejeon (KR); Ho LEE, Daejeon (KR)

(21) Appl. No.: 15/915,336

(22) Filed: Mar. 8, 2018

(30) Foreign Application Priority Data
Mar. 8, 2017 (KR) 10-2017-0029323

(51) Int. Cl. B60H 3/06; B60H 1/00; B60H 1/32

(52) U.S. Cl. CPC B60H 3/0608; B60H 2003/065; B60H 1/3204; B60H 1/00564

(57) ABSTRACT

Provided are a filter cover including: a body; a pair of fastening parts protruding from both end of the body in a length direction thereof and coupled to coupling parts formed in an air conditioning case; a first reinforcement rib having one side fixed to a front surface of the body in a width direction thereof and the other side fixed to the fastening parts; and a support rib protruding from one side of the first reinforcement rib in a height direction and fixed to the body, and an air conditioning system for a vehicle including an air conditioning case having coupling parts formed around a filter insertion hole into which a filter is inserted, and the filter cover coupled to the air conditioning case.

### CROSS-REFERENCE TO RELATED APPLICATIONS

This application claims priority under 35 U.S.C. § 119 to Korean Patent Application No. 10-2017-0029323, filed on Mar. 8, 2017, in the Korean Intellectual Property Office, the disclosure of which is incorporated here in by reference in its entirety.

### TECHNICAL FIELD

The following disclosure relates to a filter cover coupled to an air conditioning case to cover a filter insertion hole of the air conditioning case into which an air filter is inserted, and an air conditioning system for a vehicle having the same.

### BACKGROUND

In general, an air conditioning system for a vehicle includes an outer air introducing part 12 into which air outside the vehicle flows, and an inner air introducing part 14 into which inside air of the vehicle flows as illustrated in FIG. 1, and the air flowing into the air conditioning system is purified through an air filter mounted in an air conditioning case 10 and is then discharged to the inside of the vehicle.

In addition, since the air filter purifies air by filtering contaminants contained in the air passing therethrough, the contaminants are attached to the air filter. Therefore, if the air filter is used for a predetermined time or more, the air filter should be detached from the air conditioning case 10 and be replaced. To this end, a filter insertion hole 16 for inserting the air filter is formed in the air conditioning case 10, and a filter cover 40 for opening and closing the filter insertion hole 16 is coupled to the air conditioning case 10 to cover the filter insertion hole 16.

However, in the conventional filter cover, for example, hook shaped fastening parts are formed at both ends thereof so that the fastening parts of both ends of the filter cover are coupled to the air conditioning case. When the filter cover is detached, one of the fastening parts of both ends of the filter cover coupled to the air conditioning case may be first detached. In this case, when only one of the fastening parts of the filter cover, from which the fastening part is detached, is first pulled and the filter cover is rotated at a certain angle or more, the fastening part on the side that the filter cover is coupled to the air conditioning case may be broken.

That is, portions to which the fastening parts formed at both ends of the filter cover are connected have structural weak rigidity, and as described above, when only one of the fastening parts of the filter cover is first detached and is rotated, a large moment acts on the fastening part coupled to the air conditioning case, which may result in the break of the fastening part.

### RELATED ART DOCUMENT

### Patent Document

KR 10-1550730 B1 (2015.09.01)

### SUMMARY

An embodiment of the present invention is directed to providing filter cover in which structural rigidity of fastening parts formed at both ends of the filter cover are improved so that the fastening parts are not broken when the filter cover is detached, and an air conditioning system for a vehicle having the same.

In one general aspect, a filter cover 1000 includes a body 100; a pair of fastening parts 200 protruding from both end of the body 100 in a length direction thereof and coupled to coupling parts 1300 formed in an air conditioning case 1100; a first reinforcement rib 300 having one side fixed to a front surface of the body 100 in a width direction thereof and the other side fixed to the fastening parts 200; and a support rib 310 protruding from one side of the first reinforcement rib 300 in a height direction and fixed to the body 100.

The fastening part 200 may include a first support part 210 extending externally from an end portion of the body 100 in the length direction thereof; a second support part 220 extending from the first support part 210 in a width direction; and a fastening means 230 extending from the second support part 220, and the other side of the first reinforcement rib 300 may be fixed to a front end of the first support part 210 in the width direction.

The body 100 may have a protruding rib 110 protruding from the front surface of the body 100 in a width direction thereof, and the support rib 310 may be fixed to the protruding rib 110.

The filter cover may further include a second reinforcement rib 400 having one side fixed to a rear surface of the body 100 width direction thereof and the other side fixed to the fastening part 200.

The fastening part 200 may include a first support part 210 extending externally from an end portion of the body 100 in the length direction thereof; a second support part 220 extending from the first support part 210 in the width direction; and a fastening means 230 extending from the second support part 220, and the other side of the second reinforcement rib 400 may be fixed to an inner surface of the second support part 220 in the length direction.

The filter cover may further include a third reinforcement rib 500 having one side fixed to a side surface of the body 100 in the length direction thereof and the other side fixed to the fastening part 200.

In another general aspect, an air conditioning system 2000 for a vehicle includes an air conditioning case 1100 in which a filter insertion hole 1200 into which a filter is inserted is formed, and a pair of coupling parts 1300 are formed to be spaced apart from each other around the filter insertion hole 120; and the filter cover 1000 in which fastening parts 200 are coupled to the pair of coupling parts 1300.

The coupling parts 1300 of the air conditioning case 1100 may have concave grooves formed backwardly in the width direction thereof and projections 1310 protruding from a front end in the width direction thereof, the fastening parts 200 of the filter cover 1000 may have the catching protrusions 231 protruding therefrom, and the fastening parts 200 may be inserted into and coupled to the coupling parts 1300, and the catching protrusions 231 may be caught in the projections 1310 of the coupling parts 1300 in a state in which the fastening parts 200 are coupled to the coupling parts 1300 so that the fastening parts 200 are non released in a direction opposite to the direction in while the fastening parts 200 are inserted.

### BRIEF DESCRIPTION OF THE DRAWINGS

FIG. 1 is a perspective view illustrating an air conditioning system for a vehicle including the conventional filter cover and air conditioning case.

FIGS. 2 and 3 are an assembled perspective view and an exploded perspective view illustrating a filter cover and an air conditioning system for a vehicle having the same according to an exemplary embodiment of the present invention.

FIG. 4 is a perspective view illustrating a filter cover according to an exemplary embodiment of the present invention.

FIGS. 5 and 6 illustrate partially enlarged views of the filter cover according to an exemplary embodiment of the present invention.

FIG. 7 is a front view illustrating the filter cover according to an exemplary embodiment of the present invention.

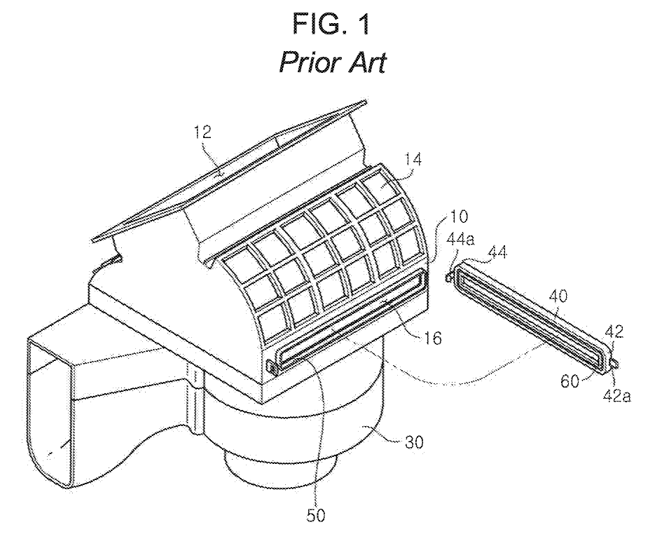

### DETAILED DESCRIPTION OF MAIN ELEMENTS

| 1000: | filter cover | | |
|---|---|---|---|
| 100: | body | 110: | protruding rib |
| 200: | fastening part | | |
| 210: | first support part | 220: | second support part |
| 230: | fastening means | 231: | catching protrusion |
| 300: | first reinforcement rib | 310:: | support rib |
| 400: | second reinforcement rib | | |
| 500: | third reinforcement rib | | |
| 2000: | air conditioning system for vehicle | | |
| 1100: | air conditioning case | | |
| 1200: | filter insertion hole | | |
| 1300: | coupling part | 1310: | projection |

### DETAILED DESCRIPTION OF EMBODIMENTS

Hereinafter, a filter cover and an air conditioning system for a vehicle having the same according to the present invention having the configuration as described above will be described in detail with reference the accompanying drawings.

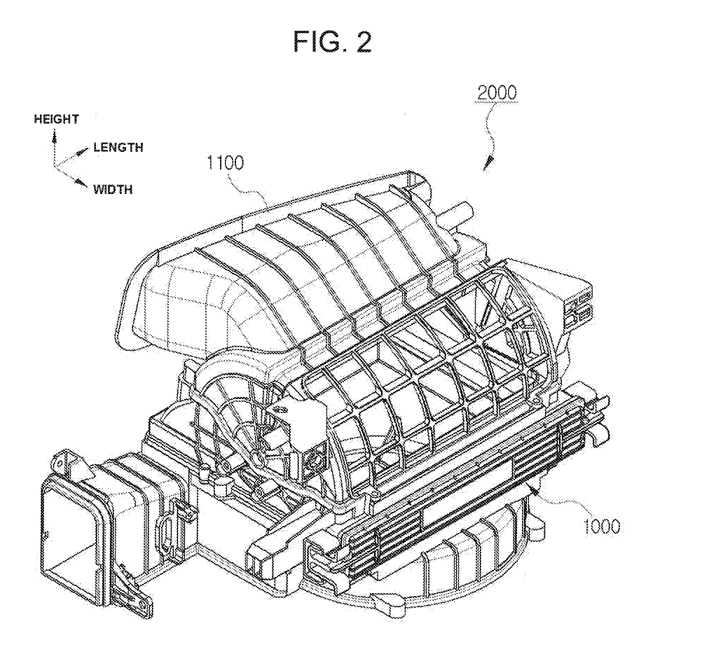

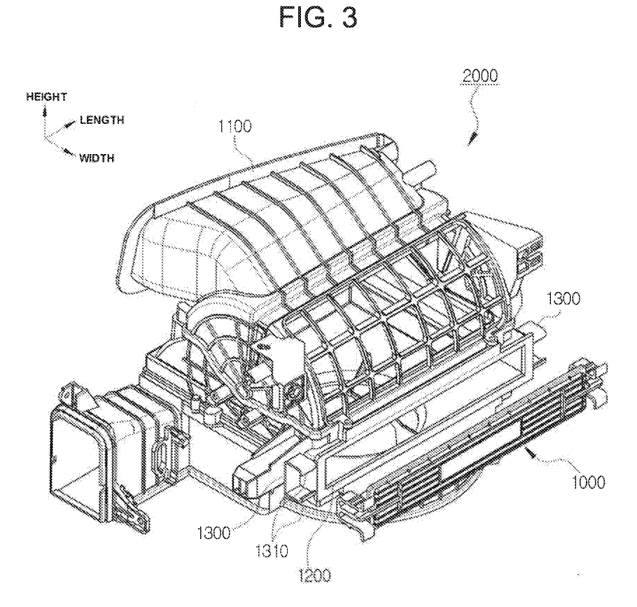

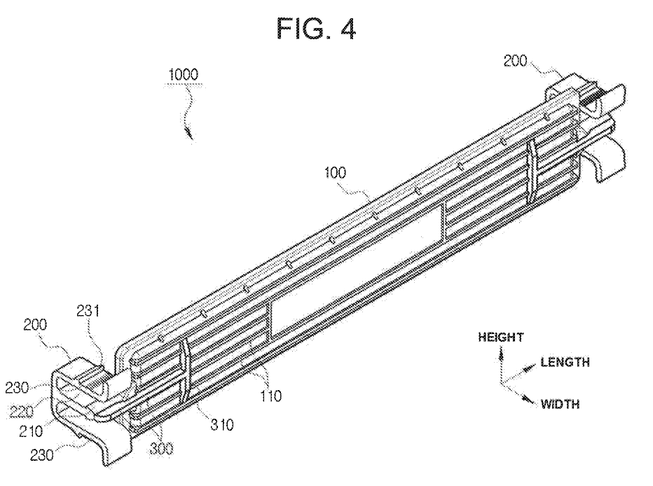

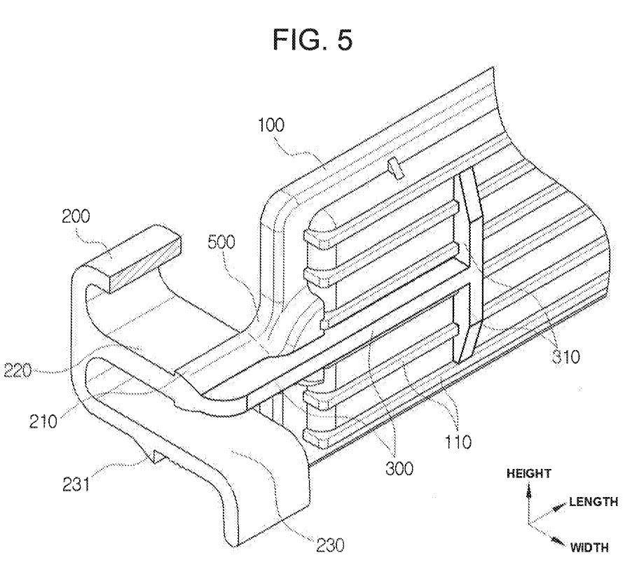

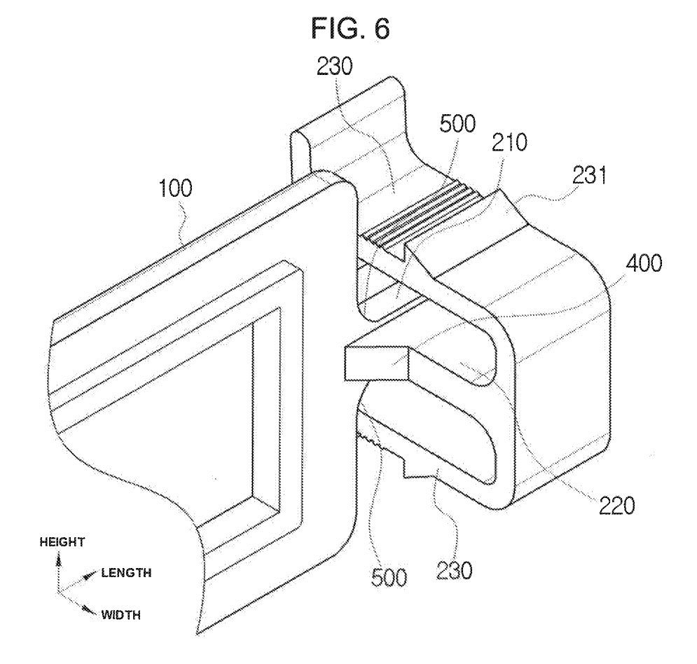

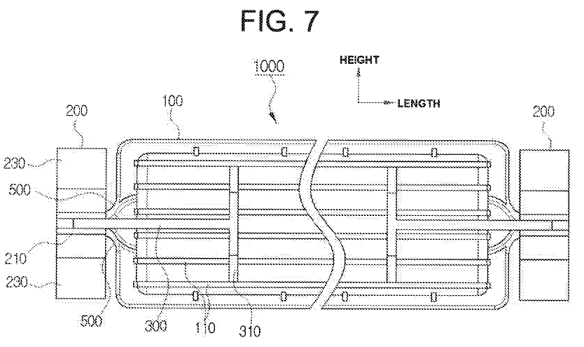

FIGS. 2 and 3 are an assembled perspective view and an exploded perspective view illustrating a filter cover and an air conditioning system for a vehicle having the same according to an exemplary embodiment of the present invention, FIG. 4 is a perspective view illustrating a filter cover according to an exemplary embodiment of the present invention, FIGS. 5 and 6 illustrate partially enlarged views of the filter cover according to an exemplary embodiment of the present invention, and FIG. 7 is a front view illustrating the filter cover according to an exemplary embodiment of the present invention.

As illustrated, a filter cover 1000 according to an exemplary embodiment of the present invention may include a body 100; a pair of fastening parts 200 protruding from both end of the body 100 in a length direction thereof and coupled to coupling parts 1300 formed in an air conditioning case 1100; a first reinforcement rib 300 having one side fixed to a front surface of the body 100 in a width direction thereof and the other side fixed to the fastening parts 200; and a support rib 310 protruding from one side of the first reinforcement rib 300 in a height direction and fixed to the body 100.

First, the body 100 may have a form corresponding to form of a filter insertion hole 1200 to cover the filter insertion hole 1200 formed in the air conditioning case 1100 so that an air filter may be inserted, and may be formed in, for example, a rectangular shape elongated in the length direction as compared to the height direction as illustrated. In addition, the body 100 may be formed in various forms capable of covering the filter insertion hole 1200, and may be formed in, for example, a plate shape to be wider than the filter insertion hole 1200.

The fastening parts 200 may externally protrude from both ends of the body 100 in the length direction thereof, and the fastening parts 200 may be variously formed to be coupled and fixed to the coupling parts 1300 formed at both sides in the length direction around the filter insertion hole 1200 of the air conditioning case 1100. As an example, as illustrated, the coupling part 1300 formed in the air conditioning case 1100 may be formed in a substantially C-shaped groove, the fastening parts 200 may be formed so as to be inserted and coupled into the coupling part 1300 in a width direction correspondingly, and the fastening part 200 may be formed in a form of hook that may be inserted into the coupling part 1300 and be then caught in and fixed to the coupling part 1300.

The first reinforcement rib 300 may be elongated in the length direction, one side of the first reinforcement rib 300 may be fixed to the front surface of the body 100 in the width direction thereof, and the other side thereof may be fixed to the fastening part 200.

The support rib 310 may protrude from one side of the first reinforcement rib 300 so as to be extended in the height direction, and may be fixed to the body. That is, the support rib 310 may protrude from the front surface of the body 100 in the width direction thereof to the front side and may be coupled to one side of the first reinforcement rib 300. As an example, as illustrated, the support rib 310 is formed upwardly and downwardly in the height direction from an end portion of the first reinforcement rib 300, such that the first reinforcement rib 300 and the support rib 310 may be formed in a T shape.

As a result, since a moment of inertia is increased at a portion that the body 100 and the fastening part 200 are connected to each other by the first reinforcement rib 300, it is possible to improve structural strength. Further, since one end of the first reinforcement rib 300 in the length direction thereof is supported by the support rib 310, the support rib 310 is not pushed in the length direction when the portion that the body 100 and the fastening part 200 are coupled to each other is bent, thereby making it possible to prevent the first reinforcement rib 300 from being broken.

Accordingly, even if only one of the pair of fastening parts formed at both ends of the filter cover is first detached when the filter cover coupled to the air conditioning case is detached, and the filter cover is rotated, the other fastening part which is coupled to the air conditioning case may not be easily broken.

Further, the fastening part 200 includes a first support part 210 extending externally from an end portion of the body 100 in the length direction thereof; a second support part 220 extending from the first support part 210 in the width direction; and a fastening means 230 extending from the second support part 220, and the other side of the first reinforcement rib 300 may be fixed to a front end of the first support part. 210 in the width direction.

That is, the fastening part 200 may be formed by externally extending the first support part 210 from a side surface in the length direction, which is an end portion in the length direction of the body 100, and may be formed by extending the second support part 220 from the first support part 210 backwardly in the width direction, as illustrated. In addition, the fastening means 230 may be extended from a rear end of the second support part 220 in the width direction thereof. In this case, as an example, the fastening means 230 is each formed at an upper side and a lower side in the height direction based on the first support part 210 and the second support part 220 such that a pair of fastening means 230 may be formed, and catching protrusions 231 may protrude on outer surfaces of the pair of fastening means 230 facing each other and may be formed in a hook shape, as illustrated. Here, the other side of the first reinforcement rib 300 may be fixed to the front end of the first support part 210 in the width direction thereof.

Therefore, the first reinforcement rib 300 may protrude from the front end of the first support part 210 and the front surface of the body 100 in the width direction, and as a result, since the body 100, the fastening parts 200, and the first reinforcement rib 300 may be formed to be integrated with each other through an injection molding by simply modifying only a portion of the first reinforcement rib 300 in an existing mold, it is possible to easily manufacture the filter cover 1000. In addition, the support rib 310 may be easily formed by a simple modification of the injection molding in the same way.

Further, the body 100 may have a protruding rib 110 protruding from the front surface of the body 100 in the width direction thereof, and the support rib 310 may be fixed to the protruding rib 110.

That is, in order to increase structural strength of the body 100 formed in the plate shape as illustrated, the protruding rib 110 may protrude from the front surface of the body 100 in the width direction thereof, and the protruding rib 110 may be elongated in the length direction. As a result, the support rib 310 is coupled and fixed to the protruding rib 110, thereby making it possible to prevent the support rib 310 from being pushed and deformed or broken.

Further, the filter cover 1000 may further include a second reinforcement rib 400 having one side fixed to the rear surface of the body 100 in the width direction thereof and the other side fixed to the fastening part 200.

That is, as illustrated in FIG. 6, the second reinforcement rib 400 may be formed at the end portion of the body 100 in the length direction thereof, and the second reinforcement rib 400 is formed to connect the rear surface of the body 100 in the width direction thereof with the fastening part 200, so that the second reinforcement rib 400 may support the body 100 and the fastening part 200. As a result, since a moment of inertia is increased at a portion that the body 100 and the fastening part 200 are connected to each other by the second reinforcement rib 400, it is possible to improve structural strength and the portion that the body 100 and the fastening part 200 are coupled to each other may not be easily broken.

Further, the fastening cart 200 includes a first support part 210 extending externally from an end portion of the body 100 in the length direction thereof; a second support part 220 extending from the first support part 210 in the width direction; and a fastening means 230 extending from the second support part 220, and the other side of the second reinforcement rib 400 may be fixed to an inner surface of the second support part 220 in the length direction.

That is, the fastening part 200 may be formed by externally extending the first support part 210 from a side surface in the length direction, which is an end portion in the length direction of the body 100, may be formed by extending the second support part 220 from the first support part 210 backwardly in the width direction, and may be formed by extending the fastening means 230 from a rear end of the second support part 220 in the width direction, as described above. Here, one side of the second reinforcement rib 400 may be fixed to the rear surface of the body 100 in the width direction thereof, and the other side thereof may be fixed to the inner surface of the second support part 220 in the length direction.

Therefore, the second reinforcement rib 400 may protrude from the rear surface of the body 100 in the width direction thereof and may protrude in direction in which the second support part 220 is extended from the first support part 210, and as a result, since the body 100. The fastening parts 200, and the second reinforcement rib 400 may be formed to be integrated with each other through an injection molding by simply modifying only a portion of the second reinforcement rib 400 in an existing mold, it is possible to easily manufacture the filter cover 1000.

Further, the filter cover 1000 may further include a third reinforcement rib 500 having one side fixed to a side surface of the body 100 in the length direction thereof and the other side fixed to the fastening part 200.

That is, as it the third reinforcement rib 500 may have one side fixed to the side surface of the body 100 in the length direction thereof and the other side fixed to an upper surface or a lower surface of the first support part 210 of the fastening part 200 in the height direction. In this case, as an example, a pair of third reinforcement ribs 500 may be formed at both sides of the first support part 210 in the height direction, and the third reinforcement rib 500 may have a round shape to connect the body 100 and the first support part 210 to each other. As a result, since a moment of inertia is increased at a portion that the body 100 and the fastening part 200 are connected to each other by the third reinforcement rib 500, it is possible to improve structural strength and the portion that the body and the fastening part are coupled to each other may not be easily broken. Further, since the body 100, the fastening part 200, and the third reinforcement rib 500 may be formed to be integrated with each other through an injection molding by simply modifying only a portion of the third reinforcement rib 500 in an existing mold, it is possible to easily manufacture the filter cover 1000.

Further, the body 100, the fastening part 200, the first reinforcement rib 300, and the support rib 310 may be formed integrally by an injection molding using a plastic material, the body 100 and the fastening part 200 are formed of a plastic material, the first reinforcement rib 300 and the support rib 310 are formed of a metal material, and the first reinforcement rib 300 and the support rib 310 be integrally formed and are then formed integrally with the body 100 and the fastening part 200 by an insert molding. Besides, the body 100, the fastening part 200, the first reinforcement rib 300, and the support rib 310 may be formed of materials other than the plastic material, and may also be formed in various ways such that they are formed separately and are coupled to each other.

In addition, the air conditioning system 2000 for a vehicle according to the present invention may include an air conditioning case 1100 in which a filter insertion hole 1200 into which a filter may be inserted is formed, and a pair of coupling parts formed to be spaced apart from each other around the filter insertion hole 1200; and the filter cover 1000 in which the fastening parts 200 are coupled to the pair of coupling parts 1300.

In air conditioning case 1100, the filter insertion hole 1200 may be formed so that the air filter may be inserted thereinto, and the pair of coupling parts 1300 which are spaced apart from each other in the length direction may be formed around the filter insertion hole 1200. In this case, the coupling part 1300 may have a form corresponding to the fastening part 200 so as to be coupled to the fastening part 200 of the filter cover 1000. In addition, as an example, as illustrated, the coupling part 1300 formed in the air conditioning case 1100 may be formed in a substantially C-shaped groove, the fastening parts 200 of the filter cover 1000 may be formed so as to be in and coupled into the coupling part 1300 in a width direction correspondingly, and the fastening part 200 may be formed in a form of hook that may be inserted into the coupling part 1300 and be then caught in and fixed to the coupling part 1300.

Further, the coupling parts 1300 of the air conditioning case 1100 have concave grooves formed backwardly in the width direction thereof and projections 1310 protruding from front end in the width direction thereof, and the fastening parts 200 of the filter cover 1000 have the catching protrusions 231 protruding therefrom, and the fastening parts 200 are inserted into and coupled to the coupling parts 1300, and the catching protrusions 231 are caught in the projections 1310 of the coupling parts 1300 in a state in which the fastening parts 200 are coupled to the coupling parts 1300 so that the fastening parts 200 are not released in a direction opposite to the direction in which the fastening parts 200 are inserted.

That is, as an example, the coupling part 1300 of the air conditioning case 1100 is formed in a C-shaped groove and is formed in a groove which is concave backwardly in the width direction, and the projections 1310 may protrude in the direction opposite to each other from a front end of the C shape in the width direction. In addition, the fastening part 200 of the filter cover 1000 may have the catching protrusion 231 formed in a wedge shape on outer surfaces facing the fastening means 230. As a result, the fastening parts 200 in which the fastening means 230 formed in the hook shape are formed may be inserted into the concave grooves of the coupling parts 1300 backwardly in the width direction, and in this case, in the state in which the fastening parts 200 are inserted into the coupling parts 1300, the fastening parts 200 are coupled to the coupling parts 1300 so that the catching protrusions 231 of the fastening parts 200 are caught in the projections 1310 of the coupling parts 1300, thereby making it possible to allow the fastening parts 200 not to release in the front in the width direction, which the direction opposite to the direction in which the fastening parts 200 are inserted.

In addition, the pair of coupling parts 1300 formed in the air conditioning case 1100 are formed so that outer surfaces thereof in the length direction are and the fastening parts 200 may be coupled to the coupling parts 1300 so that the outer surfaces of the fastening parts 200 in the length direction not in contact with the coupling parts 1300. Therefore, it may be easy to assemble and couple the filter cover 1000 to the air conditioning case 1100 even if there is a dimensional tolerance, and even though one fastening part 200 is first detached and the filter cover 1000 is slightly rotated when the filter cover 100 is detached from the air conditioning case 1100 in the state in which the filter cover 1000 is coupled to the air conditioning case 1100, since a side surface in the length direction of the fastening part 200 which is coupled to the coupling part 1300 may be pushed externally in the length direction, it is possible to reduce the concentration of force on the portion that the body 100 and the fastening part 200 are connected to each other, thereby preventing the portion that the body and the fastening part are connected to each other from being broken.

In the filter cover and the air conditioning system for a vehicle having the same according to the present invention, even if only one of the pair of fastening parts formed at both ends of the filter cover is first detached when the filter cover coupled to the air conditioning case is detached, and the filter cover is rotated, the other fastening part which is coupled to the air conditioning case may not be easily broken.

The present invention is not limited to the above-mentioned exemplary embodiments but may be variously applied, and may be variously modified by those skilled in the art to which the present invention pertains without departing from the gist of the present invention claimed in the claims.

1. A filter cover comprising:
a body;
a pair of fastening parts protruding from both ends of the body in a length direction thereof;
a first reinforcement rib having one side fixed to a front surface of the body in a width direction thereof and the other side fixed to the fastening parts; and
a support rib protruding from one side of the first reinforcement rib in a height direction and fixed to the body.

2. The filter cover of claim 1, wherein the fastening parts include a first support part extending externally from an end portion of the body in the length direction thereof; a second support part extending from the first support part in a width direction; and a fastening means extending from the second support part, and
the other side of the first reinforcement rib is fixed to a front end of the first support part in the width direction.

3. The filter cover of claim 1, wherein the body has a protruding rib protruding from the front surface of the body in a width direction thereof, and the support rib is fixed to the protruding rib.

4. The filter cover of claim 1, further comprising a second reinforcement rib having one side fixed to a rear surface of the body in a width direction thereof and the other side fixed to the fastening part.

5. The filter cover of claim 4, wherein the fastening part includes a first support part extending externally from an end portion of the body in the length direction thereof;
a second support part extending from the first support part in the width direction; and a fastening means extending from the second support part, and
the other side of the second reinforcement rib is fixed to an inner surface of the second support part in the length direction.

6. The filter cover of claim 1, further comprising a third reinforcement rib having one side fixed to a side surface of the body in the length direction thereof and the other side fixed to the fastening part.

7. An air conditioning system for a vehicle, the air conditioning system comprising:
a compressor;
an air conditioning case having a filter insertion hole therein; a pair of coupling parts spaced apart from each other around the filter insertion hole; and
the filter cover of claim 1,
wherein in which fastening parts are coupled to the pair of coupling parts.

8. The air conditioning system of claim 7, wherein the coupling parts of the air conditioning case have concave grooves formed backwardly in the width direction thereof and projections protruding from a front end in the width direction thereof,
the fastening parts of the filter cover have the catching protrusions protruding therefrom, and
the fastening parts are inserted into and coupled to the coupling parts, and the catching protrusions are caught in the projections of the coupling parts in a state in which the fastening parts are coupled to the coupling parts so that the fastening parts are not released in a direction opposite to the direction in which the fastening parts are inserted.

9. A vehicle comprising the air conditioning system of claim 7.

10. An assembly comprising:
a filter cover; and
an air conditioning case comprising coupling parts;
wherein the filter cover comprises:
a body;
a pair of fastening parts protruding from both end of the body in a length direction thereof;
a first reinforcement rib having one side fixed to a front surface of the body in a width direction thereof and the other side fixed to the fastening parts; and
a support rib protruding from one side of the first reinforcement rib in a height direction and fixed to the body.

11. The assembly of claim 10, wherein the fastening part includes a first support part extending externally from an end portion of the body in the length direction thereof; a second support part extending from the first support part in a width direction; and a fastening means extending from the second support part, and
the other side of the first reinforcement rib is fixed to a front end of the first support part in the width direction.

12. The assembly of claim 10, wherein the body has a protruding rib protruding from the front surface of the body in a width direction thereof, and the support rib is fixed to the protruding rib.

13. The assembly of claim 10, further comprising a second reinforcement rib having one side fixed to a rear surface of the body in a width direction thereof and the other side fixed to the fastening part.

14. The assembly of claim 13, wherein the fastening part includes a first support part extending externally from an end portion of the body in the length direction thereof;
a second support part extending from the first support part in the width direction; and a fastening means extending from the second support part, and
the other side of the second reinforcement rib is fixed to an inner surface of the second support part in the length direction.

15. The assembly of claim 10, further comprising a third reinforcement rib having one side fixed to a side surface of the body in the length direction thereof and the other side fixed to the fastening part.

16. A vehicle comprising the assembly of claim 10.

17. A method comprising the step of inserting the fastening parts of the air conditioning system of claim 10 into and coupling to the coupling parts, wherein the catching protrusions are caught in the projections of the coupling parts in a state in which the fastening parts are coupled to the coupling parts so that the fastening parts are not released in a direction opposite to the direction in which the fastening parts are inserted.

18. The air conditioning system of claim 7, wherein an air filter is inserted in the filter insertion hole.
